(19) United States
(12) Patent Application Publication
(10) Pub. No.: US 2015/0071488 A1
(43) Pub. Date: Mar. 12, 2015

(54) IMAGING SYSTEM WITH VANISHING POINT DETECTION USING CAMERA METADATA AND METHOD OF OPERATION THEREOF

(71) Applicant: Sony Corporation, Tokyo (JP)

(72) Inventor: Jianing Wei, San Jose, CA (US)

(21) Appl. No.: 14/024,566

(22) Filed: Sep. 11, 2013

(51) Int. Cl. G06T 7/00

(52) U.S. Cl. CPC G06T 7/0061
USPC 382/103

(57) ABSTRACT

A system and method of operation of an imaging system includes: an image sensor for capturing a source image having image metadata; a segment image calculated from the source image; a compass angle calculated for producing a maximum value of an a posteriori probability of the compass angle, the a posteriori probability of the compass angle based on the segment image and the image metadata; an x-axis vanishing point, a y-axis vanishing point, and a z-axis vanishing point calculated based on the compass angle and the image metadata; and a display unit for displaying a display image, the display image based on the source image, the x-axis vanishing point, the y-axis vanishing point, and the z-axis vanishing point.

### TECHNICAL FIELD

The present invention relates generally to an imaging system, and more particularly to an imaging system for vanishing point detection.

### BACKGROUND ART

Modern consumer and industrial electronics, especially devices with a graphical imaging capability, such as cameras, televisions, projectors, cellular phones, and combination devices, are providing increasing levels of functionality to support modern life including three-dimensional display services. Research and development in the existing technologies can take a myriad of different directions.

As users become more empowered with the growth of three-dimensional display devices, new and old paradigms begin to take advantage of this new device space. There are many technological solutions to take advantage of this new display device opportunity. One existing approach is to display three-dimensional images on consumer, industrial, and mobile electronics such as video projectors, televisions, monitors, gaming systems, or a personal digital assistant (PDA).

Due to projective imaging in digital cameras, projections of parallel lines in 3D world converge at one point in 2D image plane which are called vanishing points. Vanishing point detection is a very important problem in computer vision. Given a single 2D image, finding the vanishing points in the image can be used as a step in geometric structure analysis of the scene, building 3D models of the scene, depth estimation from 2D images and videos etc.

Three-dimensional imaging systems have been incorporated in cameras, projectors, televisions, notebooks, and other portable products. Today, these systems aid users by capturing and displaying available relevant information, such as diagrams, maps, or videos. The display of three-dimensional images provides invaluable relevant information.

However, displaying information in three-dimensional form has become a paramount concern for the consumer. Displaying a three-dimensional image that does not correlates with the real world decreases the benefit of using the tool.

Thus, a need still remains for better imaging systems to capture and display three-dimensional images. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides method of operation of an imaging system, including: providing a source image having image metadata; calculating a segment image from the source image; calculating a compass angle for producing a maximum value of an a posteriori probability of the compass angle, the a posteriori probability based on the segment image and the image metadata; calculating an x-axis vanishing point, a y-axis vanishing point, and a z-axis vanishing point based on the compass angle and the image metadata; and calculating a display image for displaying on a display unit, the display image based on the source image, the x-axis vanishing point, the y-axis vanishing point, and the z-axis vanishing point.

The present invention provides an imaging system, including: an image sensor for capturing a source image having image metadata; a segment image calculated from the source image; a compass angle calculated for producing a maximum value of an a posteriori probability of the compass angle, the a posteriori probability of the compass angle based on the segment image and the image metadata; an x-axis vanishing point, a y-axis vanishing point, and a z-axis vanishing point calculated based on the compass angle and the image metadata; and a display unit for displaying a display image, the display image based on the source image, the x-axis vanishing point, the y-axis vanishing point, and the z-axis vanishing point.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an imaging system in an embodiment of the present invention.

FIG. 2A is an example of an xyz coordinate system.

FIG. 2B is an example of a uv coordinate system and an abc coordinate system.

FIGS. 3A, 3B, and 3C are example of imaging device orientation angles.

FIG. 4 is an example of line segments.

FIG. 5 is an example of a vanishing points pseudo code.

FIG. 6 is an exemplary block diagram for computing the a posteriori probability for the Manhattan World for Lines process.

FIG. 7 is an example of a vanishing points edge pseudo code.

FIG. 8 is an exemplary block diagram for computing the a posteriori probability for the regularized Manhattan World process.

FIG. 9 is an example of the source image.

FIG. 10 is a first example of the segment image.

FIG. 11 is a second example of the segment image.

FIG. 12 is a flow chart of a method of operation of the imaging system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGs. is arbitrary for the most part. Generally, the invention can be operated in any orientation.

The same numbers are used in all the drawing FIGs. to relate to the same elements. The embodiments have been numbered first embodiment, second embodiment, etc. as a matter of descriptive convenience and are not intended to have any other significance or provide limitations for the present invention.

The term “image” is defined as a pictorial representation of an object. An image can include a two-dimensional image, three-dimensional image, video frame, a calculate file representation, an image from a camera, a video frame, or a combination thereof. For example, the image can be a machine readable digital file, a physical photograph, a digital photograph, a motion picture frame, a video frame, an x-ray image, a scanned image, or a combination thereof. The image can be formed by pixels arranged in a rectangular array. The image can include an x-axis along the direction of the rows and a y-axis along the direction of the columns.

The horizontal direction is the direction parallel to the x-axis of an image. The vertical direction is the direction parallel to the y-axis of an image. The diagonal direction is the direction non-parallel to the x-axis and non-parallel to the y-axis.

The term “module” referred to herein can include software, hardware, or a combination thereof. For example, the software can be machine code, firmware, embedded code, and application software. Also for example, the hardware can be circuitry, processor, calculator, integrated circuit, integrated circuit cores, or a combination thereof.

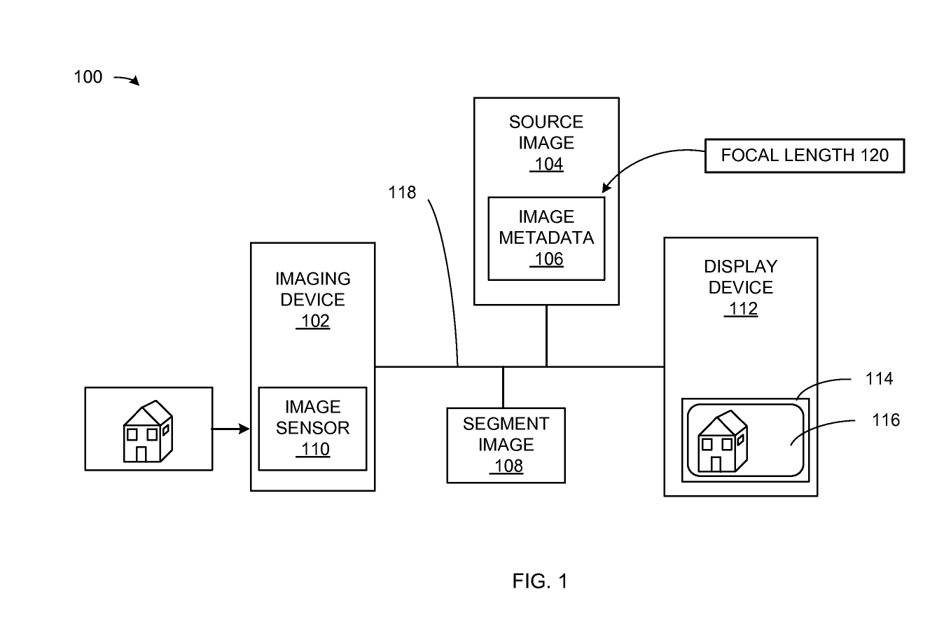

Referring now to FIG. 1, therein is shown examples of an imaging system 100 in an embodiment of the present invention. An imaging device 102 can create a source image 104 with an image sensor 110.

The imaging device 102 can form the source image 104 in a variety of ways. For example, the source image 104 can be formed by capturing a visual representation of a physical scene with an optical sensor. In another example, the source image 104 can be formed by a computer, an infrared imaging device, an ultraviolet imaging device, a scanning device, or a combination thereof.

The source image 104 can include image metadata 106. The image metadata 106 is information about the source image 104. For example, the image metadata 106 can include information about the physical properties of the imaging device when the source image 104 was created. In another example, the image metadata 106 can be the picture information recorded with the digital image in a digital camera.

The image metadata 106 can include information such as photographic properties, imaging device orientation, imaging device location, optical parameters, settings, light levels, lens information, or a combination thereof. For example, the image metadata 106 can include a focal length 120. The focal length 120 is the length between the lens and the focus point of the imaging device 102.

The imaging device 102 can form a segment image 108 from the source image 104. The segment image 108 is an image having directional information extracted from the source image 104. For example, the segment image 108 can include a line image, an edge image, a gradient image, a vector image, or a combination thereof. In another example, the segment image 108 can be a line image formed by performing line detection on the source image 104. In yet another example, the segment image 108 can be an edge image formed by performing edge detection on the source image 104.

The segment image 108 and the source image 104 having image metadata 106 can be transferred from the imaging device 102 to a display device 112 over a communication link 118. The display device 112 is a unit capable of displaying a display image 116 on a display unit 114. For example, the display device 112 can be a handheld device with a liquid crystal display unit for viewing images.

The communication link 118 is a mechanism for transferring information. For example, the communication link 118 can be an internal computer bus, an inter-device bus, a network link, or a combination thereof. Although the imaging device 102 and the display device 112 are depicted as separate devices, it is understood that the imaging device 102 the display device 112 may be implemented as a single integrated device.

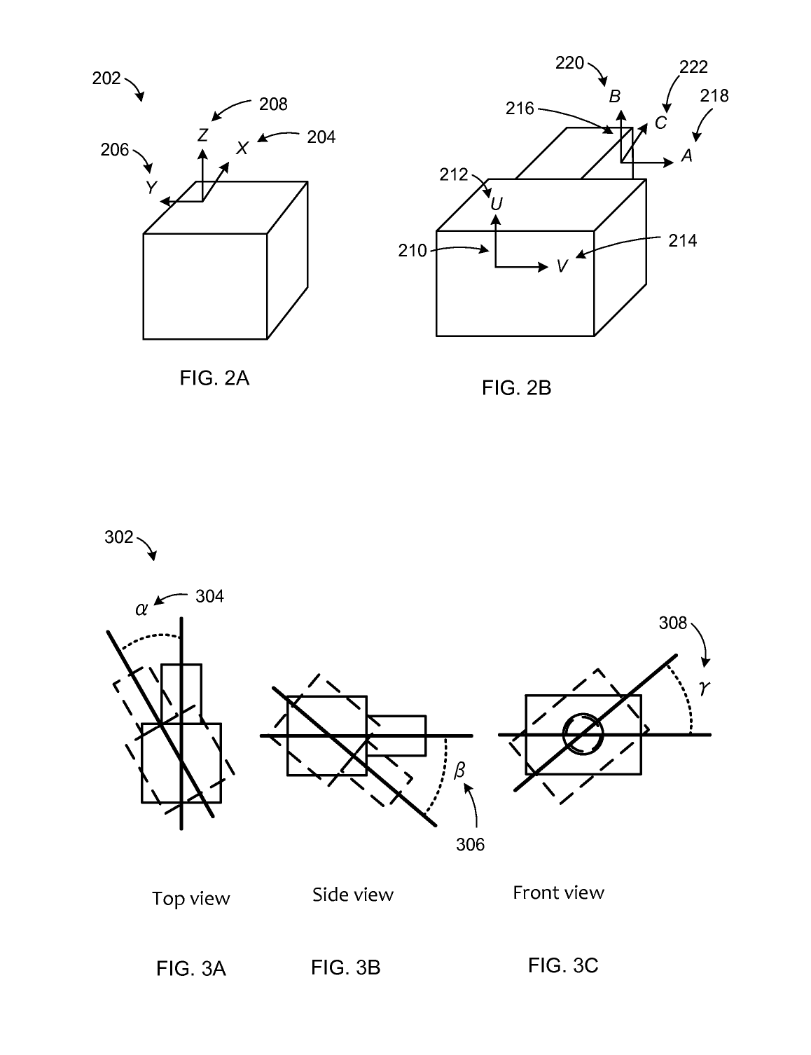

Referring now to FIG. 2A, therein is shown an example of an xyz coordinate system 202. The xyz coordinate system 202 can represent the coordinate system of the physical world for the present invention. The xyz coordinate system 202 can be depicted with a three-dimensional block. The three-dimensional block shows an x-axis 204 representing the horizontal dimension, a y-axis 206 representing the vertical dimension, and a z-axis 208 representing depth dimension.

Referring now to FIG. 2B, therein is shown an example of a uv coordinate system 210 and an abc coordinate system 216. The uv coordinate system 210 and the abc coordinate system 216 describe the reference coordinate system for the image sensor 110 of FIG. 1 and the imaging device 102 of FIG. 1, respectively.

The uv coordinate system 210 can depict the plane of the image sensor 110 of the imaging device 102. The uv coordinate system 210 indicates the two-dimensional plane of the image sensor 110. An u-axis 212 can depict the horizontal dimension of the image sensor 110. A v-axis 214 can depict the vertical dimension of the image sensor 110. The uv coordinate system 210 depicts a three-dimensional block and the plane of the image sensor 110.

The abc coordinate system 216 can depict the coordinate system relative to the imaging device, such as a camera, calculator, video recorder, or a combination thereof. The abc coordinate system 216 is illustrated by a three-dimensional cube. An a-axis 218 can depict the horizontal dimension. A b-axis 220 can depict the vertical dimension. A c-axis 222 can depict the depth dimension. The abc coordinate system 216 depicts another three-dimensional block.

The u-axis is aligned to a-axis, and v-axis is aligned to the b-axis. However, the abc coordinate system 216 is usually not aligned with Manhattan world coordinate system, the xyz coordinate system 202, due to camera orientation changes.

It has been found that three vanishing points corresponding to lines in three orthogonal directions in the Manhattan world model. The Manhattan world assumes that scenes consist of piece-wise planar surfaces with dominant directions.

Vanishing points locations and camera orientation are closely related. The first coordinate system is the xyz coordinate system 202 of the Manhattan world model. The second one is the abc coordinate system 216 of the imaging device 102, such as a camera. The third is the uv coordinate system 210 of the plane of the image sensor 110. The first two are 3D coordinate systems, and the last one is a 2D coordinate system.

Referring now to FIGS. 3A, 3B, and 3C, therein are shown example of imaging device orientation angles 302. FIG. 3A shows a top view of a compass angle 304, or alpha (α). FIG. 3B shows a side view of an elevation angle 306, or beta (β). FIG. 3C shows a front view of a twist angle 308, or gamma (γ). The imaging device orientation angles 302 \vec{Ψ}=(α, β, γ) (Psi) can be indicated by Greek alphabet letters

The abc coordinate system 216 of FIG. 2 of the imaging device 102 of FIG. 1 can rotate around the xyz coordinate system 202 of the Manhattan world. The imaging device orientation angles are defined around each of the axes. The compass angle 304 is the rotation around the z-axis 208 of FIG. 2A. The elevation angle 306 is the rotation around the y-axis 206 of FIG. 2B. The twist angle 308 is the rotation around the x-axis 204 of FIG. 2C.

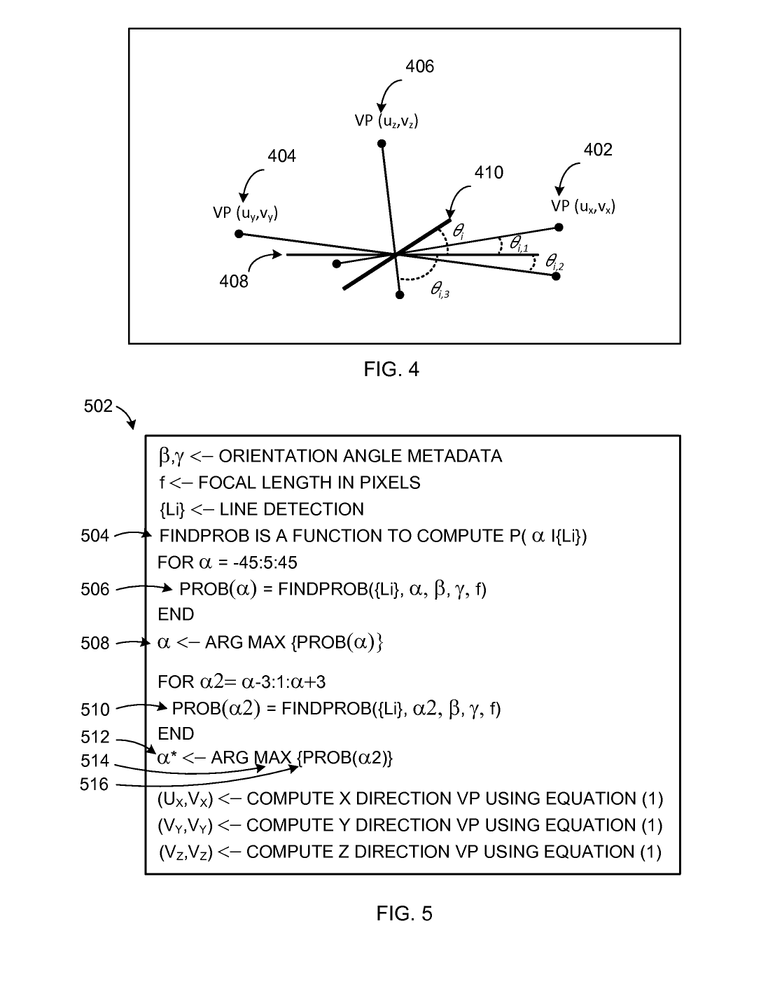

Referring now to FIG. 4, therein is shown an example of line segments 410. One of the line segments 410 is shown in relation to an x-axis vanishing point 402 (uₓ,vₓ), a y-axis vanishing point 404 (u_{y},v_{y}), and a z-axis vanishing point 406 (u_{z},v_{z}). Under the Manhattan world assumption, the three vanishing points corresponding to x, y, and z directions respectively.

One of the line segments 410, also designed “i”, has an angle theta(i) (θᵢ,) relative to a horizon line 408. The horizon line 408 is a horizontal line indicating the horizon of the source image 104 of FIG. 1.

The horizon line 408 and the line connecting center of one of the line segments 410 and the x-axis vanishing point 402 form the line angle theta (i,1) θ_{i,1}. The horizon line 408 and the line connecting center of one of the line segments 410 and y-axis vanishing point 404 form the line angle theta (i,2) (θ_{i,2}). And the horizon line 408 and the line connecting center of one of the line segments 410 and z-axis vanishing point 406 form the line angle theta (i,3) (θ_{i,3}).

It has been found that the three vanishing points, the x-axis vanishing point 402, the y-axis vanishing point 404, and the z-axis vanishing point 406, can be calculated given the focal length 120 of FIG. 1 and the imaging device orientation angles 302 of FIG. 3 \vec{Ψ}=(α, β, γ) using Equations (1A-1F).

The focal length 120, the elevation angle 306 of FIG. 3, and the twist angle 308 of FIG. 3 can be obtained from image metadata 106 of FIG. 1. That is because many of the imaging devices 102 of FIG. 1 are equipped with a sensor, such as an accelerometer, to detect device orientations. The current applications of this sensor includes: automatic image rotation when device is tilted, virtual horizon level to assist photo shooting, etc. Thus, each of the vanishing points, the x-axis vanishing point 402, the y-axis vanishing point 404, and the z-axis vanishing point 406, can be calculated if the compass angle 304 of FIG. 3 of the imaging device 102 is calculated.

The x-axis vanishing point 402 can be described as:

$$\begin{matrix}{u}_{x} = f \frac{sin α cos γ - cos α sin β sin γ}{cos α cos β} & ( 1 A ) \\ {v}_{x} = f \frac{sin α sin γ + cos α sin β cos γ}{cos α cos β} & ( 1 B )\end{matrix}$$

The y-axis vanishing point 404 can be described as:

$$\begin{matrix}{u}_{y} = - f \frac{cos α cos γ + sin α sin β sin γ}{sin α cos β} & ( 1 C ) \\ {v}_{y} = - f \frac{cos α sin γ - sin α sin β cos γ}{sin α cos β} & ( 1 D )\end{matrix}$$

The z-axis vanishing point 406 can be described as:

$$\begin{matrix}{u}_{z} = f \frac{cos β sin γ}{sin β} & ( 1 E ) \\ {v}_{z} = - f \frac{cos β cos γ}{sin β} & ( 1 F )\end{matrix}$$

Referring now to FIG. 5, therein is shown an example of a vanishing points pseudo code 502. The vanishing points pseudo code 502 can receive the orientation angle metadata including the elevation angle 306 of FIG. 3, the twist angle 308 of FIG. 3, and the focal length 120 of FIG. 1 and determine the x-axis vanishing point 402 of FIG. 4, the y-axis vanishing point 404 of FIG. 4, and the z-axis vanishing point 406 of FIG. 4 under a Manhattan World for Lines model.

The vanishing points pseudo code 502 can receive the source image 104 of FIG. 1 and perform line detection to form the segment image 108 of FIG. 1. The segment image 108 is a representation of the source image 104 with directional information extracted from the source image 104.

For example, the segment image 108 can be a line image having line segments 410 of FIG. 4. The line image can be formed using any line detection process.

The vanishing points pseudo code 502 can then calculate a coarse probability 504 for the compass angle 304 of FIG. 3 for each of the line segments 410 of FIG. 5 to identify a coarse angle maximum probability 506. The coarse angle maximum probability 506 is the maximum of the coarse probability 504 for each of the values tested for the compass angle 304.

The coarse angle maximum probability 506 indicates a coarse compass angle estimate 508. The coarse compass angle estimate 508 is the angle which produces the maximum probability 506.

The coarse probability 504 can be calculated at 5 degree intervals over the range of −45 degrees to +45 degrees. The coarse probability 504 can also be calculated at 5 degree intervals over the range of about −45 degrees to about +45 degrees. The coarse probability 504 can be calculated using the FindProb function, which is a function to calculate the condition probability of the compass angle 304 alpha for one of the line segments 410, Lᵢ.

The vanishing points pseudo code 502 can refine the estimate for the compass angle 304 by calculating a refined probability 510 for the compass angle 304 for each of the line segments 410 to identify a refined compass angle estimate 512. The refined compass angle estimate 512 is the angle which produces the maximum of the refined probability 510 for each of the values tested for the compass angle 304.

The refined probability 510 can be calculated at 1 degree intervals around the previously determined value for the coarse compass angle estimate 508 The refined probability 510 can be calculated at a variety of ranges around the previously determined value for the coarse probability 504. For example, the refined probability 510 can be calculated over from −3 to +3 degrees, −5 to +5 degrees, about −5 to about +5, or a combination thereof.

The compass angle 304 can be set to the value of the refined compass angle estimate 512. The x-axis vanishing point 402, the y-axis vanishing point 404, and the z-axis vanishing point 406, can all be calculated based on the compass angle 304, the focal length 120, the elevation angle 306, and the twist angle 308.

The process for calculating the x-axis vanishing point 402, the y-axis vanishing point 404, and the z-axis vanishing point 406 can be described in more detail below. It has been found that a maximum value of an a posteriori probability 516 estimate of the compass angle 304 (α) of the imaging device 102 of FIG. 1 can be calculated using Equation (2). Thus, the a posteriori probability 516 of the camera angle α can be written as:

$$P ( α \vert \{ {L}_{i} \} ) = \frac{P ( α ) {\prod }_{i}^{ } P ( \{ {L}_{i} \} \vert α )}{P ( \{ {L}_{i} \} )} \qquad ( 2 )$$

where P(α) is the prior probability of the compass angle 304 (α), and {Lᵢ} represents all detected lines in the segment image 108.

The segment image 108 can be generated from the source image 104 using a line detection process. For example, the line detection process can include Canny edge detection, Hough transforms, the von Gioi method, or a combination thereof.

The compass angle 304 (α) can be found by maximizing the a posteriori probability 516 as follows in Equation (3):

$$\begin{matrix}{α}^{*} = arg {max}_{α} \{ P ( α \vert \{ {L}_{i} \} ) \} \\ = arg {max}_{α} \{ P ( α ) {\prod }_{i}^{ } P ( {L}_{i} \vert α ) / P ( \{ {L}_{i} \} ) \}\end{matrix} \qquad ( 3 )$$

Note that P({Lᵢ}) is not a function of α, so it can be removed from the maximization, and α* can represent the estimated value of the compass angle 304.

It has been found that the maximum can be determined by first doing a coarse search by computing the a posteriori probability 516 on a 5 degree interval of α in the range of (−45 degrees, 45 degrees). Then the result can be refined by computing the a posteriori probability 516 on a 1 degree interval around the coarse compass angle estimate 508.

The prior probability P(α) is the probability of the compass angle 304 based on prior knowledge. The prior probability P(α) is considered uniform over the range (−45 degrees, 45 degrees). Because the prior probability is uniform, it can be considered to be a scalar constant and has no effect on the determination of the maximum probability for the tested values of the compass angle 304.

The next step is to calculate the conditional probability of P(Lᵢ|α). Consider each line i to be in one of the following four groups denoted by gᵢ where gᵢ=1 means that line i points to vanishing point (uₓ,vₓ), gᵢ=2 means that line i points to vanishing point (u_{y},v_{y}), gᵢ=3 means that line i points to vanishing point (u_{z},v_{z}), and gᵢ=4 means that line i does not point to any vanishing points.

Then, the conditional probability of P(Lᵢ|α) can be calculated using Equation (4).

$$P ( {L}_{i} \vert α ) = {\sum }_{{g}_{i} = 1}^{4} P ( {L}_{i} , {g}_{i} \vert α ) \qquad ( 4 )$$

The angles of the line segments 410 can be modeled with respect to the horizon line 408 (θᵢ) as a Gaussian random variable when gᵢ={1,2,3}. Gi represents the groups of the line segments 410.

The angle θᵢ can be treated as uniformly distributed when gᵢ=4. So the conditional probability of P(Lᵢ,gᵢ|α) can be calculated using Equation (5):

$$P ( {L}_{i} , {g}_{i} \vert α ) = \{ \begin{matrix}\frac{1}{\sqrt{2 π {σ}_{i}^{2}}} exp \{ - \frac{{( {θ}_{i} - {θ}_{i , {g}_{i}} )}^{2}}{2 {σ}_{i}^{2}} \} & {g}_{i} = 1 , 2 , 3 \\ \frac{1}{90} & {g}_{i} = 4\end{matrix} , \qquad ( 5 )$$

where σᵢ² is inversely proportional to line length, θ_{i,g}_{ᵢ} is the angle of the line connecting center of line segment and the vanishing point corresponding to gᵢ.

Given the elevation angle 306 (β) and the twist angle 308 (γ), as retrieved from the image metadata 106 of FIG. 1, the x-axis vanishing point 402, the y-axis vanishing point 404, and the z-axis vanishing point 406, can be calculated for each specific α in our coarse-to-fine search using Equations (1A-1F). Thus, we can find the angle θ_{i,g}_{ᵢ} for a given one of the line segments 410 in the segment image 108.

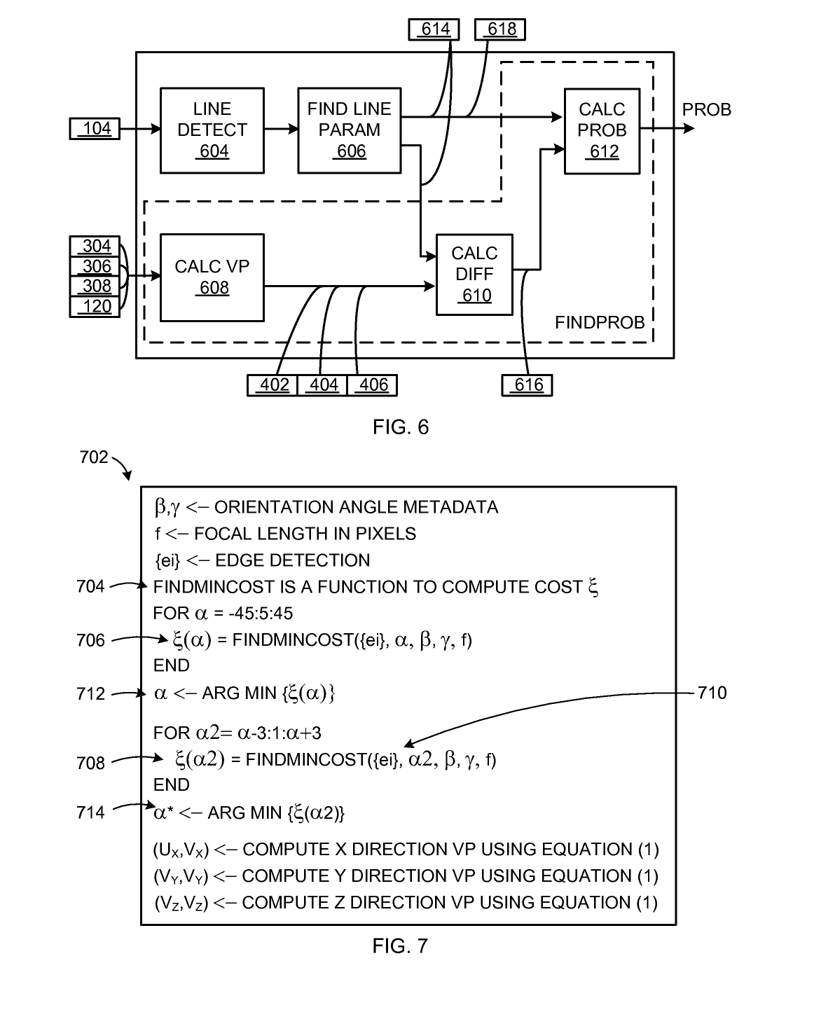

Referring now to FIG. 6, therein is shown an exemplary block diagram for computing the a posteriori probability 516 of FIG. 5 for the Manhattan World for Lines process. The a posteriori probability 516 can be calculated for the source image 104 based on the compass angle 304, the elevation angle 306, the twist angle 308, and the focal length 120. The block diagram can include a line detection module 604, a find line parameters module 606, a calculate vanishing points module 608, a calculate differences module 610, and a calculate probability module 612.

The line detection module 604 can receive the source image 104 and generate the segment image 108 of FIG. 1. The line detection module 604 can employ a line detection process to detect lines, such as the line segments 410 of FIG. 4, in the source image 104. The line detection module 604 can pass the segment image 108 to the find line parameters module 606.

The find line parameters module 606 can determine line angles 614 and line lengths 618 for each of the line segments 410 in the segment image 108. The find line parameters module 606 can iterate through the set of the line segments 410 in the segment image 108 and determine the individual values for the line angles 614 and the line lengths 618. The line angles 614 can be passed to the calculate differences module 610. The line angles 614 and the line lengths 618 can be passed to the calculate probability module 612.

The calculate vanishing points module 608 can calculate the x-axis vanishing point 402, the y-axis vanishing point 404, and the z-axis vanishing point 406 based on the focal length 120, the compass angle 304, the elevation angle 306, and the twist angle 308. The calculate vanishing points module 608 can pass the x-axis vanishing point 402, the y-axis vanishing point 404, and the z-axis vanishing point 406 for the source image 104 to the calculate differences module 610.

The calculate differences module 610 can receive the x-axis vanishing point 402, the y-axis vanishing point 404, the z-axis vanishing point 406, and the line angles 614 to determine line angle differences 616 between each of the line angles 614 with respect to the x-axis vanishing point 402, the y-axis vanishing point 404, and the z-axis vanishing point 406. The calculate differences module 610 can pass the line angle differences 616 to the calculate probability module 612.

The calculate probability module 612 can receive the line angle differences 616 from the calculate differences module 610 and the line angles 614 and the line lengths 618 of the segment image 108 from the find line parameters module 606. The calculate probability module 612 can calculate the a posteriori probability 516 based on the line angle differences 616, the line angles 614, and the line lengths 618 for the lines in the segment image 108.

The block diagram represents the vanishing points pseudo code 502 of FIG. 5. For example, the line detection module 604 represent the set of the line segments 410 {Lᵢ} in the vanishing points pseudo code 502. The FindProb function shown in the vanishing points pseudo code 502 is represented by the calculate vanishing points module 608, the calculate differences module 610, and the calculate probability module 612.

It has been discovered that calculating the compass angle 304 based on the Manhattan world from lines model and the image metadata 106 can increase accuracy of the compass angle 304 estimate. For example, the accuracy can be increased by around four percent. Using the Manhattan world from lines model and the image metadata 106 of FIG. 1 provides additional information to increase the accuracy of the estimate of the compass angle 304 and provide more accurate calculations of the x-axis vanishing point 402, the y-axis vanishing point 404, and the z-axis vanishing point 406.

Referring now to FIG. 7, therein is shown an example of a vanishing points edge pseudo code 702. The vanishing points edge pseudo code 702 can receive the orientation angle metadata including the elevation angle 306 of FIG. 3, the twist angle 308 of FIG. 3, the focal length 120 of FIG. 1, and the source image 104 of FIG. 1 and calculate the vanishing points for the source image 104.

The vanishing points edge pseudo code 702 can perform edge detection to generate the segment image 108, such as an edge image, from the source image 104. The edge image can be is a representation of the source image 104 based on edge segments 710 of the pixels in the source image 104. The segment image 108 of FIG. 1 can include the edge segments 710 calculated based on the gradient of the source image 104.

The vanishing points edge pseudo code 702 can evaluate a cost function 704 (ξ or Xi) for the segment image 108. Calculating the cost function 704 corresponds to the edge detection for generating the edge image from the source image 104. The segment image 108 can include the edge segments 710 calculated based on the gradient of the source image 104. The cost function 704 is equivalent to determining the a posteriori probability 516 of FIG. 5.

The vanishing points edge pseudo code 702 can then calculate a coarse cost minimum 706 for the cost function 704 for each of the edge segments 710 of FIG. 7 to identify the compass angle 304 of FIG. 3. The coarse cost minimum 706 is calculated at 5 degree intervals over the range of −45 degrees to +45 degrees. The coarse cost minimum 706 can also be calculated at 5 degree intervals over the range of about −45 degrees to about +45 degrees. The coarse cost minimum 708 represents the minimum cost at a minimum coarse angle 712.

The vanishing points edge pseudo code 702 can refine the estimate for the compass angle 304 by calculating a fine cost minimum 708 for the compass angle 304 for each of the edge segments 710. The fine cost minimum 708 can be calculated at 1 degree intervals around the minimum coarse angle 712 for the coarse cost minimum 706. The fine cost minimum 708 can be calculated at a variety of ranges around the previously determined value for the coarse cost minimum 706. For example, the fine cost minimum 708 can be calculated over from −3 to +3 degrees, −5 to +5 degrees, about −5 to about +5, or a combination thereof. The fine cost minimum 708 represents the minimum cost at a minimum fine angle 714.

The compass angle 304 can be set to the value of the minimum values of the fine cost minimum 708. The x-axis vanishing point 402 of FIG. 4, the y-axis vanishing point 404 of FIG. 4, and the z-axis vanishing point 406 of FIG. 4, can all be calculated based on the compass angle 304, the focal length 120, the elevation angle 306, and the twist angle 308.

It has been discovered that calculating the compass angle 304 based on the regularized Manhattan world model and the image metadata 106 can increase accuracy of the estimate of the compass angle 304. For example, the accuracy can be increased by around five percent or more. Using the regularized Manhattan world model and the image metadata 106 of FIG. 1 provides additional information to increase the accuracy of the estimate of the compass angle 304 and provide more accurate calculations of the x-axis vanishing point 402, the y-axis vanishing point 404, and the z-axis vanishing point 406.

In the vanishing points edge pseudo code 702, one of the edge segments 710 (eᵢ) is defined to be one of the edge segments 710 at the pixel i and the angle θᵢ is the edge angle at pixel i. The edge direction is orthogonal to gradient direction, so θᵢ=a tan(−du/dv), where du and dv are image gradient along u and v directions. The gradient gᵢ is similarly defined by simply replacing line i with edge i.

The maximum a posteriori estimate of α and {gᵢ} is calculated using Equation (6):

$$\{ {α}^{*} , \{ {g}_{i} \} \} = arg {max}_{α , \{ {g}_{i} \}} \{ P ( α , \{ {g}_{i} \} \vert \{ {e}_{i} \} ) \} . \qquad ( 6 )$$

It has been found that the estimate of the compass angle 304 is calculated with improved accuracy because the process jointly optimizes the set of edges, {gᵢ}. Optimizing each of the set of edges pointing to each of the x-axis vanishing point 402, the y-axis vanishing point 404, and the z-axis vanishing point 406 improves accuracy of the compass angle 304.

It has been also been found that the accuracy of the compass angle 304 is calculated with improved accuracy because the spatial dependency of the edges are taken into account, whereas different lines are typically spatially independent. Grouping the edges to take advantage of the spatial dependency of similar edges increases the likelihood that the grouped edges describe an artifact in the source image 104.

The a posteriori probability 516 of FIG. 5 for each of the tested values of the compass angle 304 can be calculated using Equation (7):

$$\begin{matrix}P ( α , \{ {g}_{i} \} \vert \{ {e}_{i} \} ) = \frac{P ( \{ {e}_{i} \} \vert α , \{ {g}_{i} \} ) P ( \{ {g}_{i} \} \vert α ) P ( α )}{P ( \{ {e}_{i} \} )} \\ = \frac{{\prod }_{i}^{ } P ( {e}_{i} \vert α , {g}_{i} ) P ( \{ {g}_{i} \} \vert α ) P ( α )}{P ( \{ {e}_{i} \} )}\end{matrix} \qquad ( 7 )$$

Further, the conditional probability term P(eᵢ|α,gᵢ) of Equation (7) can be calculated using Equation (8):

$$P ( {e}_{i} \vert α , {g}_{i} ) = \{ \begin{matrix}\frac{1}{2} exp \{ - \vert {θ}_{i} - {θ}_{i , {g}_{i}} \vert \} & {g}_{i} = 1 , 2 , 3 \\ exp \{ - τ \} & {g}_{i} = 4\end{matrix} \qquad ( 8 )$$

where τ is a pre-defined constant.

The joint prior probability of {gᵢ} can be calculated as

$$P ( \{ {g}_{i} \} \vert α ) = P ( \{ {g}_{i} \} ) = \frac{1}{W} {\prod }_{( i , j ) ∈ C}^{ } exp \{ - λ δ ( {g}_{i} - {g}_{j} ) \} \qquad ( 9 )$$

where W is a normalizing constant, λ is a pre-specified constant scalar, δ( ) is a Kronecker delta function, and C is the set of cliques ((i, j)εC indicates that pixel i and j are neighbors). The Kronecker delta function δ(gᵢ, gⱼ) is a piecewise function for gᵢ and gⱼ where the value is 1 when gᵢ=gⱼ and 0 otherwise. The set of cliques (i,j) represent the set of edge segments 710 that are neighbors in a 3×3 window.

The prior probability P(α) is considered to be uniform within its range. Because the prior probability P(α) is constant, it can be factored out when determining the minimum value of the cost function 704.

Thus, maximizing the probability in Equation (7) is equivalent to minimizing the following cost function. The cost function 704 can be expressed as in Equation (10):

$$ξ = {\sum }_{i}^{ } \vert {θ}_{i} - {θ}_{i , {g}_{i}} \vert + λ {\sum }_{( i , j ) ∈ C}^{ } δ ( {g}_{i} - {g}_{j} ) \qquad ( 10 )$$

where θ_{i,g}_{ᵢ} is a function of α, pixel i, and gᵢ.

Therefore, the compass angle 304 can be determined using Equation (11):

$$\{ {α}^{*} , \{ {g}_{i} \} \} = ar g {min}_{α , \{ {g}_{i} \}} \{ ξ ( α , \{ {g}_{i} \} ) \} \qquad ( 11 )$$

Minimizing the cost function in Equation (10) can be done in a variety of ways. For example, the cost function 704 can be minimized using graph-cut or any other optimization approaches.

It has been found that calculating the cost function can increase accuracy of calculation of the compass angle 304 by using the regularization term. The second term of Equation (10) can be considered as a regularization term, which is why the process is named regularized Manhattan world. The regularization term penalizes neighboring edges pointing to different vanishing points and results in the calculation of a more accurate value for the compass angle 304.

It has been discovered that determining the x-axis vanishing point 402, the y-axis vanishing point 404, and the z-axis vanishing point 406, based on the calculated value of the compass angle 304 and the retrieved values of the elevation angle 306 and the twist angle 308 can increase processing speed and reduce computational complexity.

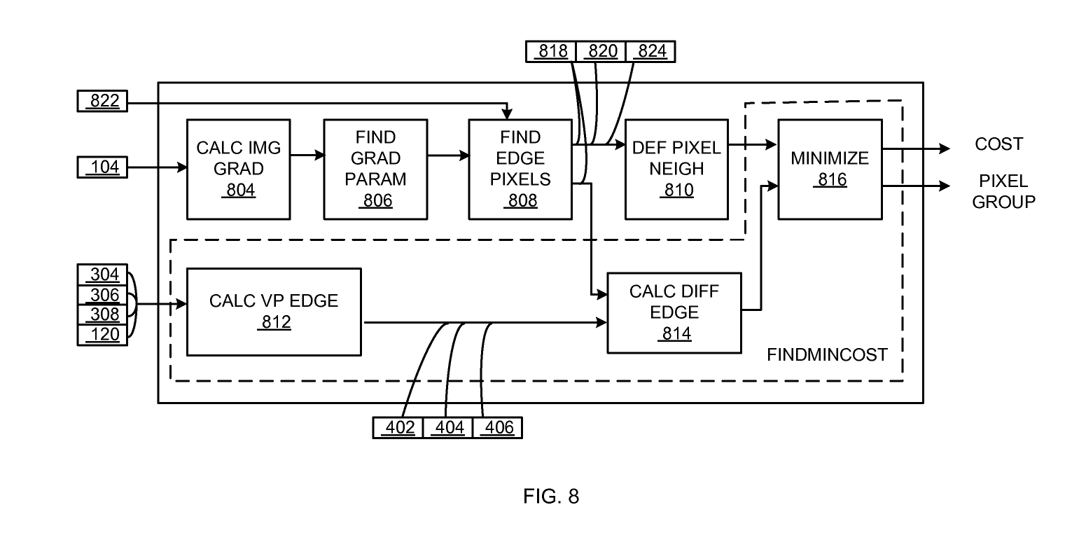

Referring now to FIG. 8, therein is shown an exemplary block diagram for computing the a posteriori probability 516 of FIG. 5 for the regularized Manhattan World process. The regularized Manhattan World process has been developed where the detected lines are considered as observations, and the orientation angle α is inferred from the observations.

The a posteriori probability 516 can be calculated for the source image 104 based on the compass angle 304, the elevation angle 306, the twist angle 308, and the focal length 120. The block diagram can include a calculate image gradient module 804, a find gradient parameters module 806, a find edge pixels module 808, a define pixel neighborhood module 810, a calculate vanishing points edge module 812, a calculate differences edge module 814, and a minimizing module 816.

The calculate image gradient module 804 can receive the source image 104 and calculate the segment image 108 of FIG. 1, such as the edge image. The edge image can be calculated in a variety of ways. For example, the edge image can be calculated by thresholding the gradient magnitude of the source image 104. The calculate image gradient module 804 has a similar purpose to the line detection module 604 of FIG. 6 but calculated the segment image 108 using edge detection processing.

The find gradient parameters module 806 can determine gradient angles 818 and gradient magnitudes 820 for the segment image 108. The gradient angles 818 can be passed to the calculate differences edge module 814. The gradient angles 818 and the gradient magnitudes 820 can be passed to the find edge pixels module 808.

The find edge pixels module 808 can iterate through the set of the gradient angles 818 and the gradient magnitudes 820 from the segment image 108 and determine which edge pixels 824 represent valid edges using the gradient threshold 822. The gradient threshold 822 is a minimum difference between the values of two pixels to determine if an edge exists or not. The edge pixels 824 can be pass to the define pixel neighborhood module 810.

The define pixel neighborhood module 810 can determine values for an array of pixels for defining the set of cliques where pixels i and j are neighbors. The clique is the set of neighboring pixels. Pixels are neighbors if they are included within an array, such as a 3×3 pixel array. The pixel neighborhood information can be passed to the minimizing module 816.

The calculate vanishing points edge module 812 can calculate the x-axis vanishing point 402, the y-axis vanishing point 404, and the z-axis vanishing point 406 based on the focal length 120, the compass angle 304, the elevation angle 306, and the twist angle 308. The calculate vanishing points module 608 of FIG. 6 can pass the x-axis vanishing point 402, the y-axis vanishing point 404, and the z-axis vanishing point 406 for the source image 104 to the calculate differences edge module 814.

The calculate differences edge module 814 can receive the x-axis vanishing point 402, the y-axis vanishing point 404, the z-axis vanishing point 406, and the line angles 614 to determine gradient angle differences between each of the gradient angles 818 with respect to the x-axis vanishing point 402, the y-axis vanishing point 404, and the z-axis vanishing point 406. The calculate differences edge module 814 can pass the gradient angle differences to the minimizing module 816.

The minimizing module 816 can receive the gradient angle differences from the calculate differences edge module 814 and the gradient angles 818, the gradient magnitudes 820, and the pixel neighborhood information from the define pixel neighborhood module 810. The minimizing module 816 can calculate the a posteriori probability 516, the cost function 704 of FIG. 7, and the pixel groups {gᵢ}, such as the pixel neighborhood information. The minimizing module 816 can calculate the graph cut function to determine the minimum cost.

The block diagram represents a portion of the vanishing points edge pseudo code 702 of FIG. 7. For example, the calculate image gradient module 804 can calculate the set of edge segments 710 of FIG. 7 {eᵢ} in the vanishing points edge pseudo code 702. The FindMinCost function shown in the vanishing points edge pseudo code 702 is represented by the calculate vanishing points edge module 812, the calculate differences edge module 814, and the minimizing module 816.

It has been discovered that calculating the x-axis vanishing point 402, the y-axis vanishing point 404, and the z-axis vanishing point 406 using the compass angle 304 based on edges instead of lines, the estimation of the compass angle 304 becomes more robust and less dependent on line detection algorithms, since line detection is usually more difficult than simple edge detection.

It has been discovered that calculating the compass angle 304 using the image metadata 106 of FIG. 1 can increase accuracy of the compass angle 304 estimate. Compared to the Manhattan world method without metadata, the accuracy can be increased up to a factor of ten. Using the image metadata 106 including the focal length 120, the elevation angle 306, the twist angle 308, the sensor size, and image resolution provides additional information to increase the accuracy of the estimate of the compass angle 304 and provide more accurate calculations of the x-axis vanishing point 402, the y-axis vanishing point 404, and the z-axis vanishing point 406.

It has been discovered that calculating the compass angle 304 based on the Manhattan world from lines model and the image metadata 106 can increase accuracy of the compass angle 304 estimate. Compared to the original Manhattan world method plus metadata, the accuracy can be increased by around four percent. Using the Manhattan world from lines model and the image metadata 106 provides additional information to increase the accuracy of the estimate of the compass angle 304 and provide more accurate calculations of the x-axis vanishing point 402, the y-axis vanishing point 404, and the z-axis vanishing point 406.

It has been discovered that calculating the compass angle 304 based on the regularized Manhattan world model and the image metadata 106 can increase accuracy of the estimate of the compass angle 304. Compared to Manhattan world from lines model, the accuracy can be increased by around five percent or more. Using the regularized Manhattan world model and the image metadata 106 provides additional information to increase the accuracy of the estimate of the compass angle 304 and provide more accurate calculations of the x-axis vanishing point 402, the y-axis vanishing point 404, and the z-axis vanishing point 406.

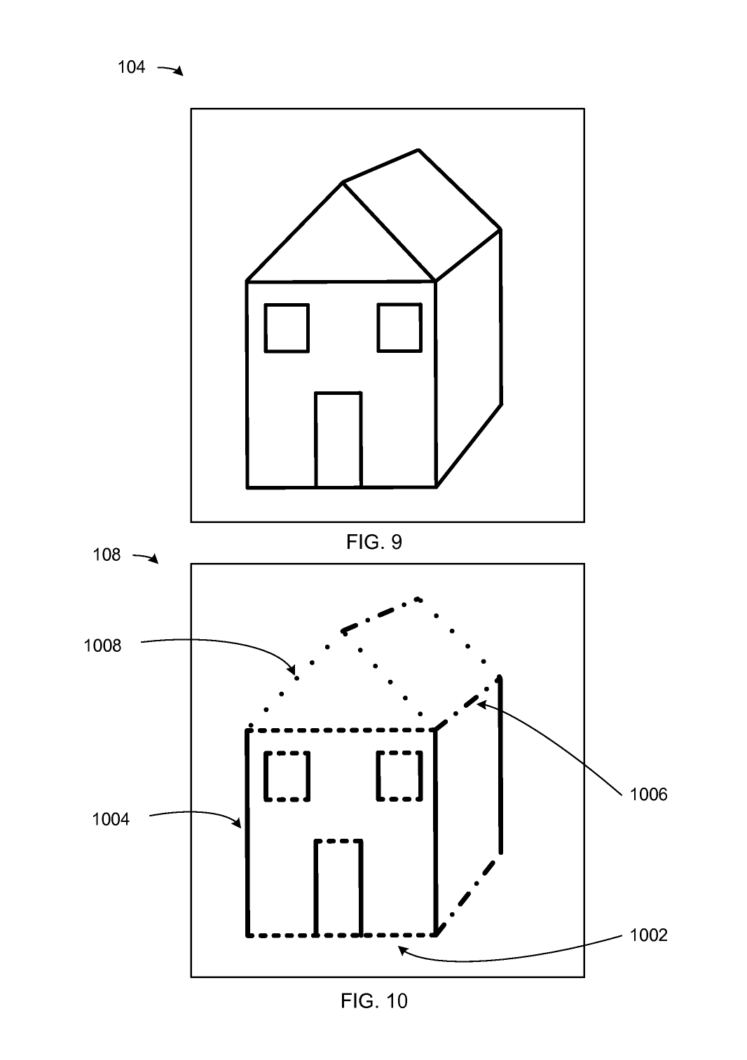

Referring now to FIG. 9, therein is shown an example of the source image 104. The source image 104 can be a two-dimensional image of a three-dimensional scene. For example, the source image 104 can be an image of a house.

Referring now to FIG. 10, therein is shown a first example of the segment image 108. The segment image 108 of FIG. 1 can represent a line image where the source image 104 of FIG. 1 has been created by performing a line detection process on the source image 104. The segment image 108 representing the line image can be used in the Manhattan world with lines model.

The segment image 108 can include lines that point toward the x-axis vanishing point 402 of FIG. 4, the y-axis vanishing point 404 of FIG. 4, and the z-axis vanishing point 406 of FIG. 4. The segment image 108 can include x-lines 1002, which point toward the x-axis vanishing point 402. The segment image 108 can include y-lines 1004, which point toward the y-axis vanishing point 404. The segment image 108 can include z-lines 1006, which point toward the z-axis vanishing point 406. The segment image 108 can also include non-aligned lines 1008 which do not point at one of the vanishing points and can be considered random lines or edges.

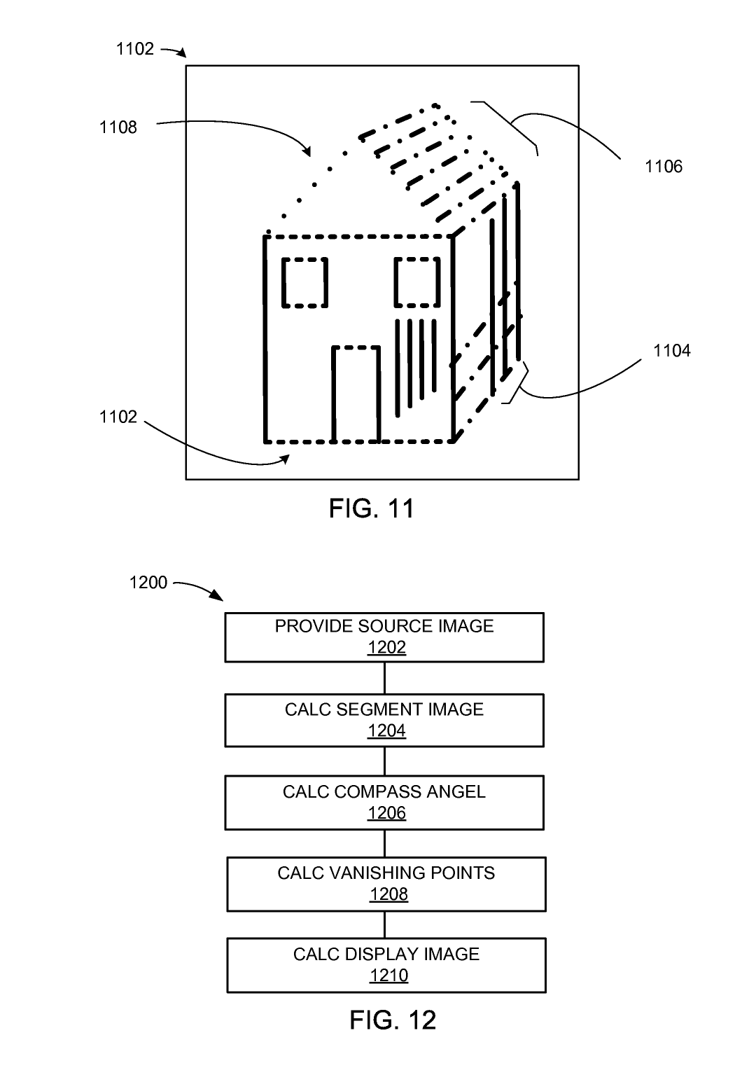

Referring now to FIG. 11, therein is shown a second example of the segment image 108 of FIG. 1. The segment image 108 can represent a gradient image where the source image 104 of FIG. 1 has been created by performing an edge detection process on the source image 104. The segment image 108 representing the line image can be used in the regularized Manhattan world model.

The segment image 108 can include lines that point toward the x-axis vanishing point 402 of FIG. 4, the y-axis vanishing point 404 of FIG. 4, and the z-axis vanishing point 406 of FIG. 4. The segment image 108 can include x-edges 1102, which point toward the x-axis vanishing point 402. The segment image 108 can include y-edges 1104, which point toward the y-axis vanishing point 404. The segment image 108 can include z-edges 1106, which point toward the z-axis vanishing point 406. The segment image 108 can also include non-aligned edges 1108 which do not point at one of the vanishing points and can be considered random edges.

Referring now to FIG. 12, therein is shown a flow chart of a method 1200 of operation of the imaging system in a further embodiment of the present invention. The method 1200 includes: providing a source image having image metadata in a block 1202; calculating a segment image from the source image in a block 1204; calculating a compass angle for producing a maximum value of an a posteriori probability of the compass angle, the a posteriori probability based on the segment image and the image metadata in a block 1206; calculating an x-axis vanishing point, a y-axis vanishing point, and a z-axis vanishing point based on the compass angle and the image metadata in a block 1208; and calculating a display image for displaying on a display unit, the display image based on the source image, the x-axis vanishing point, the y-axis vanishing point, and the z-axis vanishing point in a block 1210.

It has been discovered that the present invention thus has numerous aspects. The present invention valuably supports and services the historical trend of reducing costs, simplifying systems, and increasing performance. These and other valuable aspects of the present invention consequently further the state of the technology to at least the next level.

Thus, it has been discovered that the imaging system of the present invention furnishes important and heretofore unknown and unavailable solutions, capabilities, and functional aspects for efficiently coding and decoding video content for high definition applications. The resulting processes and configurations are straightforward, cost-effective, uncomplicated, highly versatile and effective, can be surprisingly and unobviously implemented by adapting known technologies, and are thus readily suited for efficiently and economically manufacturing video coding devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an imaging system comprising:
providing a source image having image metadata;
calculating a segment image from the source image;
calculating a compass angle for producing a maximum value of an a posteriori probability of the compass angle, the a posteriori probability based on the segment image and the image metadata;
calculating an x-axis vanishing point, a y-axis vanishing point, and a z-axis vanishing point based on the compass angle and the image metadata; and
calculating a display image for displaying on a display unit, the display image based on the source image, the x-axis vanishing point, the y-axis vanishing point, and the z-axis vanishing point.

2. The method as claimed in claim 1, wherein calculating the segment image includes calculating a segment image as a line image by performing line detection on the source image.

3. The method as claimed in claim 1, wherein calculating the compass angle includes:
calculating a coarse compass angle estimate of a set of the a posteriori probability calculated at 5 degree intervals over the range of about −45 degrees to about 45 degrees;
calculating a refined compass angle estimate from a set of the a posteriori probability calculated at 1 degree intervals over the range of about −5 degrees to about +5 degrees around the coarse compass angle estimate; and
setting the compass angle based on the refined compass angle estimate.

4. The method as claimed in claim 1, wherein calculating the segment image includes calculating a segment image as a gradient image by performing edge detection on the source image.

5. The method as claimed in claim 1, wherein calculating the compass angle includes:
calculating a minimum coarse cost angle for a coarse cost minimum of a cost function calculated at 5 degree intervals over the range of −45 degrees to 45 degrees;
calculating a minimum fine cost angle for a fine cost minimum of the cost function calculated at 1 degree intervals over the range of about −5 degrees to about +5 degrees around the minimum coarse cost angle; and
setting the compass angle based on the minimum fine cost angle.

6. A method of operation of an imaging system comprising:
providing a source image having image metadata with a focal length, an elevation angle, and a twist angle;
calculating a segment image from the source image;
calculating a compass angle for producing a maximum value of an a posteriori probability of the compass angle, the a posteriori probability based on the segment image, the focal length, the elevation angle, and the twist angle;
calculating an x-axis vanishing point, a y-axis vanishing point, and a z-axis vanishing point based on the compass angle and the image metadata; and
calculating a display image for displaying on a display unit, the display image based on the source image, the x-axis vanishing point, the y-axis vanishing point, and the z-axis vanishing point.

7. The method as claimed in claim 6, wherein calculating the compass angle includes calculating the maximum value of the a posteriori probability of the compass angle based on the equation:
$$P ( α \vert \{ {L}_{i} \} ) = \frac{P ( α ) {\prod }_{i}^{ } P ( \{ {L}_{i} \} \vert α )}{P ( \{ {L}_{i} \} )}$$
where:
P(α|{Lᵢ}) is the maximum value of the a posteriori probability of the compass angle,
P(α) is the prior probability of the compass angle, and
{Lᵢ] represents all detected lines in the segment image.

8. The method as claimed in claim 6, wherein calculating the compass angle includes calculating the maximum value of the a posteriori probability of the compass angle based on the equation:
$$P ( {L}_{i} \vert α ) = {\sum }_{{g}_{i} = 1}^{4} P ( {L}_{i} , {g}_{i} \vert α )$$
$$where \text{:}$$
$$P ( {L}_{i} , {g}_{i} \vert α ) = \{ \begin{matrix}\frac{1}{\sqrt{2 π {σ}_{i}^{2}}} exp \{ - \frac{{( {θ}_{i} - {θ}_{i , {g}_{i}} )}^{2}}{2 {σ}_{i}^{2}} \} & {g}_{i} = 1 , 2 , 3 \\ \frac{1}{90} & {g}_{i} = 4\end{matrix} , with \\ P ( {L}_{i} \vert α ) = {\sum }_{{g}_{i} = 1}^{4} P ( {L}_{i} , {g}_{i} \vert α ) ,$$
σᵢ² is inversely proportional to line length, and
θ_{i,g}_{ᵢ} is the angle of the line connecting center of line segment and the vanishing point corresponding to gᵢ.

9. The method as claimed in claim 6 wherein calculating the vanishing points includes:
calculating the x-axis vanishing point using:
$${u}_{x} = f \frac{sin α cos γ - cos α sin β sin γ}{cos α cos β} , and$$
$${v}_{x} = f \frac{sin α sin γ + cos α sin β cos γ}{cos α cos β} ;$$
calculating the y-axis vanishing point using:
$${u}_{y} = - f \frac{cos α cos γ + sin α sin β sin γ}{sin α cos β} , and$$
$${v}_{y} = - f \frac{cos α sin γ - sin α sin β cos γ}{sin α cos β} ;$$
and calculating the y-axis vanishing point using:
$${u}_{z} = f \frac{cos β sin γ}{sin β} , and$$
$${v}_{z} = - f \frac{cos β cos γ}{sin β} .$$

10. The method as claimed in claim 6, further comprising:
calculating the compass angle for the minimum value of a cost function using:
$$ξ = {\sum }_{i}^{ } \vert {θ}_{i} - {θ}_{i , {g}_{i}} \vert + λ {\sum }_{( i , j ) ∈ C}^{ } δ ( {g}_{i} - {g}_{j} )$$
where θ_{i,g}_{ᵢ} is a function of α, pixel i, and gᵢ.

11. An imaging system comprising:
an image sensor for capturing a source image having image metadata;
a segment image calculated from the source image;
a compass angle calculated for producing a maximum value of an a posteriori probability of the compass angle, the a posteriori probability of the compass angle based on the segment image and the image metadata;
an x-axis vanishing point, a y-axis vanishing point, and a z-axis vanishing point calculated based on the compass angle and the image metadata; and
a display unit for displaying a display image, the display image based on the source image, the x-axis vanishing point, the y-axis vanishing point, and the z-axis vanishing point.

12. The system as claimed in claim 11, wherein the segment image is a line image calculated by performing line detection on the source image.

13. The system as claimed in claim 11, wherein the compass angle includes:
a coarse compass angle estimate of a set of the a posteriori probability of the compass angle calculated at 5 degree intervals over the range of about −45 degrees to about 45 degrees;
a refined compass angle estimate of a set of the a posteriori probability calculated at 1 degree intervals over the range of about −5 degrees to about +5 degrees around the coarse compass angle estimate; and
the compass angle is based on the refined compass angle estimate.

14. The system as claimed in claim 11, wherein the segment image is a gradient image by performing edge detection on the source image.

15. The system as claimed in claim 11, wherein the compass angle includes:
a minimum coarse cost angle for a coarse cost minimum of a cost function calculated at 5 degree intervals over the range of about −45 degrees to about 45 degrees;
a minimum fine cost angle for a fine cost minimum of the cost function calculated at 1 degree intervals over the range of about −5 degrees to about +5 degrees around the minimum coarse cost angle; and
the compass angle is based on the minimum fine cost angle.

16. The system as claimed in claim 11, wherein:
the source image having image metadata includes a focal length, an elevation angle, and a twist angle; and
the compass angle calculated for producing the maximum value of the a posteriori probability of the compass angle and the maximum value of the a posteriori probability is based on the segment image, the focal length, the elevation angle, and the twist angle.

17. The system as claimed in claim 16, wherein the compass angle includes the maximum value of the a posteriori probability of the compass angle calculated based on the equation:
$$P ( α \vert \{ {L}_{i} \} ) = \frac{P ( α ) {\prod }_{i}^{ } P ( \{ {L}_{i} \} \vert α )}{P ( \{ {L}_{i} \} )}$$
where:
P(α|{Lᵢ}) is the maximum value of the a posteriori probability of the compass angle,
P(α) is the prior probability of the compass angle, and
{Lᵢ] represents all detected lines in the segment image.

18. The system as claimed in claim 16, wherein the compass angle includes the maximum value of the a posteriori probability of the compass angle calculated based on the equation:
$$P ( {L}_{i} \vert α ) = {\sum }_{{g}_{i} = 1}^{4} P ( {L}_{i} , {g}_{i} \vert α )$$
$$where \text{:}$$
$$P ( {L}_{i} , {g}_{i} \vert α ) = \{ \begin{matrix}\frac{1}{\sqrt{2 π {σ}_{i}^{2}}} exp \{ - \frac{{( {θ}_{i} - {θ}_{i , {g}_{i}} )}^{2}}{2 {σ}_{i}^{2}} \} & {g}_{i} = 1 , 2 , 3 \\ \frac{1}{90} & {g}_{i} = 4\end{matrix} , with \\ P ( {L}_{i} \vert α ) = {\sum }_{{g}_{i} = 1}^{4} P ( {L}_{i} , {g}_{i} \vert α ) ,$$
σᵢ² is inversely proportional to line length, and
θ_{i,g}_{ᵢ} is the angle of the line connecting center of line segment and the vanishing point corresponding to gᵢ.

19. The system as claimed in claim 16, wherein the x-axis vanishing point, the y-axis vanishing point, and the z-axis vanishing point includes:
the x-axis vanishing point is calculated using:
$${u}_{x} = f \frac{sin α cos γ - cos α sin β sin γ}{cos α cos β} , and$$
$${v}_{x} = f \frac{sin α sin γ + cos α sin β cos γ}{cos α cos β} ;$$
the y-axis vanishing point is calculated using:
$${u}_{y} = - f \frac{cos α cos γ + sin α sin β sin γ}{sin α cos β} , and$$
$${v}_{y} = - f \frac{cos α sin γ - sin α sin β cos γ}{sin α cos β} ;$$
and
the y-axis vanishing point is calculated using:
$${u}_{z} = f \frac{cos β sin γ}{sin β} , and$$
$${v}_{z} = - f \frac{cos β cos γ}{sin β} .$$

20. The system as claimed in claim 16, wherein the compass angle for the minimum value of a cost function is calculated using:
$$ξ = {\sum }_{i}^{ } \vert {θ}_{i} - {θ}_{i , {g}_{i}} \vert + λ {\sum }_{( i , j ) ∈ C}^{ } δ ( {g}_{i} - {g}_{j} )$$
where θ_{i,g}_{ᵢ} is a function of α, pixel i, and gᵢ.
